(19) United States
(12) Patent Application Publication
(10) Pub. No.: US 2017/0044808 A1
(43) Pub. Date: Feb. 16, 2017

(54) HINGE STRUCTURE

(71) Applicant: Xiamen Yarn-Way Enterprise Co., Ltd., Xiamen City (CN)

(72) Inventor: Yang-Sung Liao, Xiamen (CN)

(21) Appl. No.: 15/131,031

(22) Filed: Apr. 18, 2016

(30) Foreign Application Priority Data
Aug. 14, 2015 (CN) 201520612081.0

(51) Int. Cl. E05D 7/00; E05D 9/00; F16C 11/12

(52) U.S. Cl. CPC E05D 7/00; F16C 11/12; E05D 9/005

(57) ABSTRACT

A hinge structure includes two leaves with locking holes and a pivot adapted to be in connection with the two leaves, where each leaf is made of polymer composite carbon fiber and pivot is a pivoting piece made of aromatic polyamide curtain fabric, where the pivoting piece is sandwiched between the two leaves and bonded together therewith by means of thermosetting molding to form a sheet body. The present invention is silent without needing maintenance, labor-saving in door opening and closing, long in hinge life, light-weighted in weight, thin in thickness and good in strength.

### TECHNICAL FIELD OF THE INVENTION

The present invention relates to a hinge structure, and more particularly to a hinge structure, which is simple in structure and good in strength.

### DESCRIPTION OF THE PRIOR ART

The so-called “hinge” is a connection element adapted to couple two objects pivotally to each other. A traditional hinge structure is formed by coupling two leaves 1′ to each other through a pivot 2′, where on each leaf 1′ is configured with locking holes 11′ for the locking of an object to be attached.

The current hinge structure has the following defects:
1. the weight is large and the material cost is high because it is made of metal.
2. the volume is large such that objects with a small gap between them cannot be connected properly because the flaky leaves are coupled to each other through a cylindrical pivot, causing the volume of whole product to be large relatively.

### SUMMARY OF THE INVENTION

The object of the present invention is to provide a hinge structure, which is low in production cost, light and thin, and good in strength.

To achieve the object mentioned above, the present invention proposes a hinge structure, including two leaves with locking holes and a pivot adapted to be in connection with the two leaves, where each leaf is made of polymer composite carbon fiber and pivot is a pivoting piece made of aromatic polyamide curtain fabric, where the pivoting piece is sandwiched between the two leaves and bonded together therewith by means of thermosetting molding to form a sheet body.

Each leaf is made of polymer composite carbon fiber by means of warp and weft weaving to form a layer structure, and the pivoting piece is sandwiched and connected fixedly between the two layers.

After the above solution is adopted, the connection function of the leaves of the hinge can be satisfied because polymer composite carbon fiber has a light weight and high strength. In addition the pivoting piece formed of aromatic polyamide curtain fabric also has a light weight, flexibility and good toughness, capable of realizing the pivot function, thereby achieving the surface joining effect. Therefore, the hinge is silent upon surface joining without needing maintenance (the addition of lubricant), labor-saving upon door opening and closing, long in life, light and thin, and good in strength.

### BRIEF DESCRIPTION OF THE DRAWINGS

FIG. 1 is a schematically perspective view of a conventional hinge;

FIG. 2 is a schematically perspective view of a hinge structure according to the present invention; and

FIG. 3 is a partly enlarged view of FIG. 2.

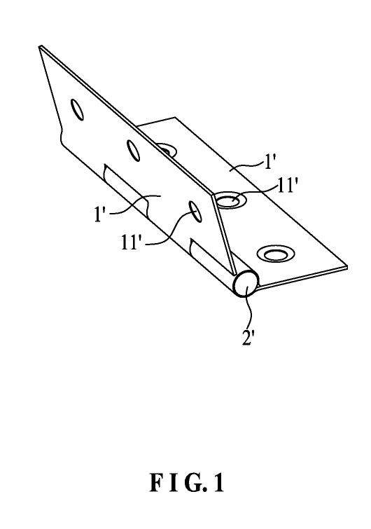

### DETAILED DESCRIPTION OF THE PREFERRED EMBODIMENTS

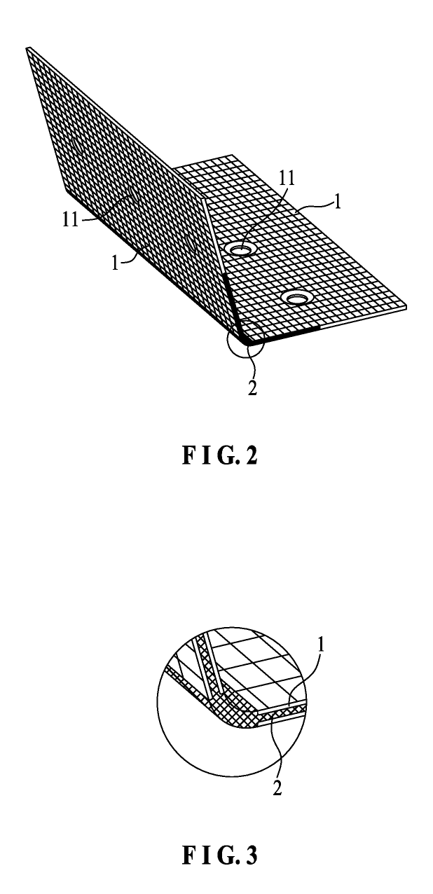

Referring to FIGS. 2 and 3, a hinge structure of the present invention includes two leaves 1 respectively having locking holes 11 and a pivot in connection with the two leaves 1, where the leaf 1 is made of polymer composite fiber, and pivot is a pivoting piece 2 made of aromatic polyamide curtain fabric, and sandwiched between the two leaves 1 and combined therewith by means of thermosetting molding.

Each leaf 1 is made of polymer composite carbon fiber by means of warp and weft weaving to form a layer structure, and the pivoting piece 2 is sandwiched and fixed between the two layers.

The connection function of the leaves 1 of the hinge can be satisfied because polymer composite carbon fiber has a light weight and high strength. In addition, the pivoting piece 2 formed of aromatic polyamide curtain fabric also has a light weight, flexibility and good toughness, capable of realizing the pivot function, thereby achieving the surface joining effect.

The hinge structure according to the present invention has the following advantages compared with conventional hinge structures:

1. the leaf 1 of the hinge is light-weighted and strong because it made of obviously light-weighted polymer composite carbon fiber (compared with metal). In addition, the hinge is silent upon surface joining without needing maintenance (the addition of lubricant), labor-saving upon door opening and closing, and long in life.

2. the hinge so-made completely is a sheet body, small in volume, light in weight, thin in thickness, suitable for the joining of objects with a small gap between them, and flexible and convenient for application because the pivoting piece 2 made of aromatic polyamide curtain fabric is used to be in connection with the leaves 1.

I claim:

1. A hinge structure, comprising two leaves with locking holes and a pivot adapted to be in connection with said two leaves, wherein each said leaf is made of polymer composite carbon fiber and pivot is a pivoting piece made of aromatic polyamide curtain fabric, wherein said pivoting piece is sandwiched between said two leaves and bonded together therewith by means of thermosetting molding to form a sheet body.

2. The structure according to claim 1, wherein each said leaf is made of polymer composite carbon fiber by means of warp and weft weaving to form a layer structure, and said pivoting piece is sandwiched and connected fixedly between said two layers.
